(19) United States
(12) Patent Application Publication
(10) Pub. No.: US 2026/0207981 A1
(43) Pub. Date: Jul. 23, 2026

(54) FIRE SUPRESSION SYSTEM

(71) Applicant: Rob J. Evans, Glendale, AZ (US)

(72) Inventor: Rob J. Evans, Glendale, AZ (US)

(21) Appl. No.: 19/452,762

(22) Filed: Jan. 19, 2026

Related U.S. Application Data
(60) Provisional application No. 63/746,723, filed on Jan. 17, 2025.
(60) Provisional application No. 63/746,739, filed on Jan. 17, 2025.

(51) Int. Cl. A62C 37/48; A62C 31/03

(52) U.S. Cl. CPC A62C 37/48; A62C 31/03

(57) ABSTRACT

A fire suppression system includes a valve opening device to open a valve for release of water during a fire. The valve opening device includes a weight suspended by a release chain, the release chain having at least one meltable portion; a rotatable disk having an arm extending therefrom attached to the weight; a valve having a stem attached to a central portion of the rotatable disk; a water inlet pipe connected to an inlet of the valve; and a water outlet pipe connected to an outlet of the valve; wherein. In a case where the release chain breaks because the meltable portion melts, the rotatable disk rotates in a predetermined direction as the weight falls downwardly and the stem of the valve turns in the predetermined direction along with the rotatable disk, opening the valve.

### CROSS-REFERENCE TO RELATED APPLICATIONS

This application claims the benefit of provisional patent applications Ser. Nos. 63/746,723 and 63/746,739, both filed-on Jan. 17, 2025, the subject matter of each of which is incorporated herein by reference.

### TECHNICAL FIELD

The application relates to a fire suppression system including a mechanism for automatically opening a valve to trigger water release during a fire.

### BACKGROUND

Many buildings include a water sprinkler system. In a water sprinkler system, a network of plumbing hidden between walls and ceilings connect the sprinklers. High temperatures from an early-stage fire trigger one or more of the sprinklers to release high-pressure water. However, the fire may not be otherwise suppressed.

### SUMMARY

A fire suppression system includes a valve opening device. The valve opening device includes a weight suspended by a release chain, the release chain having at least one meltable portion; a rotatable disk having an arm extending therefrom attached to the weight; a valve having a stem attached to a central portion of the rotatable disk; a water inlet pipe connected to an inlet of the valve; and a water outlet pipe connected to an outlet of the valve; wherein, in a case where the release chain breaks because the meltable portion melts, the rotatable disk rotates in a predetermined direction as the weight falls downwardly and the valve turns in the predetermined direction along with the rotatable disk, opening the valve.

### BRIEF DESCRIPTION OF THE DRAWINGS

FIG. 1 illustrates a front perspective view of a valve opening device, according to an embodiment.

FIG. 2 illustrate a side perspective view of the valve opening device.

FIG. 3 illustrates an example release chain useable in conjunction with the valve opening device, according to an embodiment.

FIG. 4 illustrates a side view of an example valve useable in conjunction with the ball valve opening device, according to an embodiment.

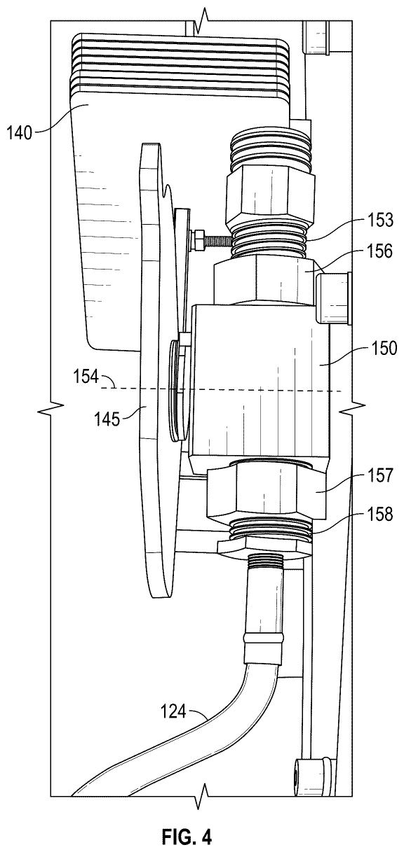

FIG. 5 illustrates a front perspective view of a water-sprayed doorway, according to an embodiment.

### DETAILED DESCRIPTION OF EXAMPLE EMBODIMENTS

Details of the various embodiments will now be discussed by reference to the drawings.

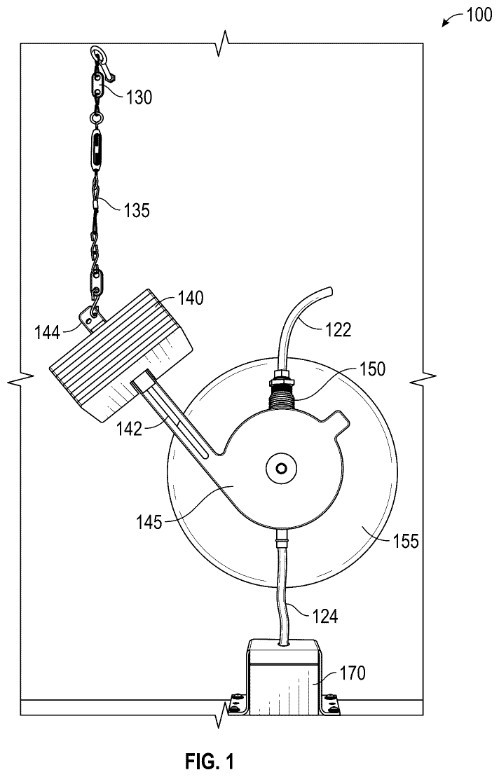

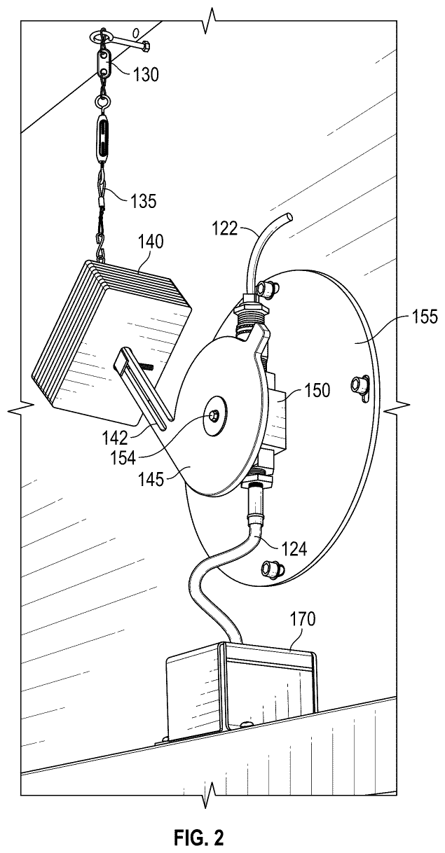

Referring to FIGS. 1 and 2, an example valve opening device 100 is illustrated. As shown, the valve opening device 100 includes a weight 140 suspended by a release chain 135. As shown, the weight 140 can include one or more stacked metal plates. However, the weight 140 can simply be a single piece. Arm 142 extends from the bottom of the weight 140. As shown, the arm 142 is integral to a rotatable disk 145. It is to be understood that the weight 140 and the rotatable disk 145 are rigidly connected via the arm 142. Notably, the arm 142 can be positioned at various angles different from that shown.

The rotatable disk 145 includes a central axis 154. The central axis 154 of the rotatable disk attaches to a stem of a ball valve 150. The ball valve 150 includes a water inlet pipe 122 that is a pressurized water feed. Output from the ball valve 150 is a water outlet pipe 124. If the stem of the ball valve 150 is turned in a counter-clockwise manner, the ball valve 150 opens, allowing water from the water inlet pipe 122 to flow into the water outlet pipe 124. However, in the normal (or “off”) position, as shown in the figures, the ball valve 150 is closed. Thus, the normal position of the valve opening device 100 is such that water does not flow from the water inlet pipe 122 into the water outlet pipe 124.

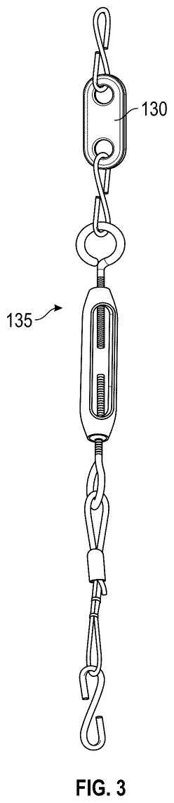

As mentioned, the weight 140 is supported by the release chain 135. FIG. 3 shows a close-up view of the release chain 135. As shown, the release chain 135 includes a series of inter-connected links. However, one or more of the links is a fusible link 130. The fusible link 130 is designed to melt and break apart when exposed to high temperatures. The fusible link 130 may include, for example, two metal plates held together by solder or the fusible link 130 may be made entirely of material that melts around a certain temperature indicative of a fire.

As mentioned, the normal or “off” position of the valve opening device 100 is such that the ball valve 150 is closed. In a fire, though, the ball valve 150 can be opened. Then the valve opening device 100 would be in the “on” position. More particularly, if the temperature of the fire exceeds a certain value, the fusible link 130 will melt. The melted fusible link 13 will then cause the release chain 135 to break such that the weight 140 is no longer supported by the release chain 135. In that case, gravity will pull the weight 140 toward the ground and in so doing will cause a counter-clockwise rotation of the rotatable disk 145. Since the stem of the ball valve 150 is fixedly attached to the rotatable disk 145, as the rotatable disk 145 turns in the counter-clockwise direction, the stem of the ball valve 150 will turn with the rotatable disk 145. Accordingly, in this situation, the ball valve 150 will open—causing the pressurized water in the water inlet pipe 122 to flow through the ball valve 150 and then through the water outlet pipe 124.

Notably, the arm position can be monitored and when released an alerting device or fire alarm panel (FAP) can be notified. For example, the release can be detected using a resistor—a change in resistance can be used to indicate release of the arm 145.

It is be appreciated that the water that flows from the water outlet pipe 124 due to the foregoing may then be used to help extinguish the fire. Unlike a sprinkler system, the water will not spray only from the ceiling. Instead, it may be provided elsewhere. For example, the water could be supplied to a doorway.

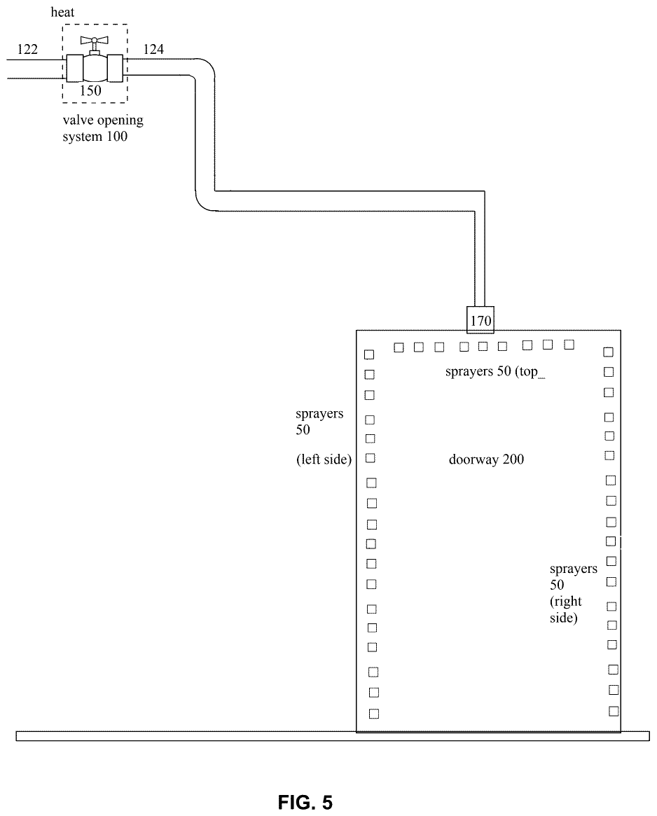

Referring to FIG. 5, a water-sprayed doorway is illustrated. The water sprayed doorway system includes a doorway 200. The doorway can be an entrance to any type of door. Along the interior of frame of the doorway 200, a series of spaced-apart water sprayers 50 are disposed. The spaced-apart water sprayers 50 can be situated on the left side, right side, and the top portions of the interior of the frame, as shown. The water sprayers 50 may be nozzles. The nozzles may be adjustable to create different types of spray (e.g., mist, high-pressure, cone). The nozzles can be fluidly connected in series by at least one continuous pipe 124. When activated, the pipe 124 contains pressurized water. The pipe 124 may include the junction 170, as shown. The junction 170 can be a T-connection, for example.

The pipe 124 is an outlet from the valve 150, as shown. The inlet into the valve is pipe 122, as shown. When the valve 150 is opened, water from the inlet pipe 122 passes through the valve 150 into the outlet 124. The pipe 122 can originate from the same system that feeds a water sprinkler system.

In an embodiment, the valve can be a manual valve. That is, the valve can be manually opened. In other embodiments, the valve can be automatically activated. That is, the valve can be automatically opened responsive to activation (e.g., responsive to heat sensation or a fire alarm activation). In the illustrated case, the valve 150 is a ball valve, the stem of which can be rotated responsive to a fusible link being melted. In this embodiment, the valve opening system 100 is used to open the valve 150.

While this invention has been described in conjunction with the various exemplary embodiments outlined above, it is evident that many alternatives, modifications and variations will be apparent to those skilled in the art. Accordingly, the exemplary embodiments of the invention, as set forth above, are intended to be illustrative, not limiting. Various changes may be made without departing from the spirit and scope of the invention.

What is claimed is:

1. A fire suppression system, comprising:
a valve;
a water inlet pipe connected to an inlet of the valve;
a water outlet pipe connected to an outlet of the valve; and
a valve-opening device that opens the valve responsive to at least one link of a release chain breaking;
wherein water flows from the water inlet pipe through the valve and out from the water outlet pipe, for use in suppressing a fire.

2. The fire suppression system of claim 1, wherein the release chain includes at least one meltable portion.

3. The fire suppression system of claim 1, wherein the meltable portion includes a fusible link.

4. The fire suppression system of claim 3, wherein heat from the fire melts the fusible link, causing the link to break.

5. The fire suppression system of claim 1, further comprising:
a plurality of sprayers situated along one or more portions of a periphery of a doorway;
wherein the water from the water outlet pipe is in fluid communication with the plurality of sprayers.

6. The fire suppression system of claim 5, wherein one or more of the plurality of sprayers includes an adjustable nozzle.

7. The fire suppression system of claim 1, wherein the valve-opening device further comprises:
a weight suspended by the release chain;
a rotatable disk having an arm extending therefrom that is attached to the weight; and
a stem attached to the valve having a central portion of the rotatable disk;
wherein,
in a case where the release chain breaks because the meltable portion melts,
the rotatable disk rotates in a predetermined direction as the weight falls downwardly and the stem of the valve turns in the predetermined direction with the rotatable disk, opening the valve.

8. The fire suppression system of claim 7, wherein the weight includes a plurality of stacked plates.

9. The fire suppression system of claim 7, wherein a fire alarm panel is notified when the release chain breaks.

10. The fire suppression system of claim 1, wherein the valve is a ball valve.

11. The fire suppression system of claim 1, wherein a fire alarm panel is notified when the release chain breaks.

12. The fire suppression system of claim 1, wherein the release chain includes a plurality of connected links.

13. The fire suppression system of claim 1, wherein at least one of the links includes solder.

14. The fire suppression system of claim 1, wherein the water is pressurized.
